(19) United States
(12) Patent Application Publication
(10) Pub. No.: US 2015/0242882 A1
(43) Pub. Date: Aug. 27, 2015

(54) APPARATUS, SYSTEM, AND METHOD FOR SYNCING CONSUMER ENGAGEMENT OPPORTUNITIES WITH BROADCAST MEDIA

(71) Applicant: Blanchard Enterprises, LLC, Farmington, UT (US)

(72) Inventor: Rod N. Blanchard, Farmington, UT (US)

(21) Appl. No.: 14/631,794

(22) Filed: Feb. 25, 2015

Related U.S. Application Data
(60) Provisional application No. 61/944,466, filed on Feb. 25, 2014.

(51) Int. Cl. G06Q 30/02; G06F 17/30

(52) U.S. Cl. CPC G06Q 30/0236; G06Q 30/0235; G06F 17/30581

(57) ABSTRACT

Described herein is a method for electronic-based opportunities for consumer engagement that includes broadcasting an offer for participating in an opportunity via an electronic medium. The method also includes accepting the offer by generating from an information handling device of a participant an electronic text-based message or input from a computer application.

### CROSS-REFERENCE TO RELATED APPLICATION

This application claims the benefit of U.S. Provisional Patent Application No. 61/944,466, filed Feb. 25, 2014, which is incorporated herein by reference.

### FIELD

This application relates generally to broadcast media consumption, and more particularly to enhancing the experience for consumers of broadcast media.

### BACKGROUND

The opportunities for the general public to invest, participate, or engage in real-time opportunities while watching or listening to broadcast media is limited. Traditionally, a user wishing to take advantage of opportunities presented in broadcast media requires extra time, effort, and resources to research, determine, and locate such opportunities and then seek out ways to fulfill them. Often, the interest and excitement to participate in opportunities presented in broadcast media is lost due to the extra steps required to take advantage of the opportunities.

### SUMMARY

The subject matter of the present application has been developed in response to the present state of the art, and in particular, in response to the problems and needs of conventional methods of engaging consumers of broadcast media. Generally, the subject matter of the present application has been developed to provide a method, apparatus, and system for temporally syncing broadcast media with opportunities to engage a consumer that overcome at least some of the above-discussed shortcomings of the prior art.

According to one embodiment, a method for electronic-based crowd funding includes broadcasting an offer for participating in a crowd funding event via an electronic medium. The method also includes accepting the offer by generating from an information handling device of a participant an electronic text-based message or input from a computer application.

In some implementations, the method further includes registering the participant, and verifying the electronic text-based message or input from the computer application is from a registered participant. The method may also include verifying the participant qualifies to participate in the offer based on at least one of regulation and offer-defined criteria. According to yet some implementations, the method includes confirming with the participant acceptance of the offer, and following confirmation of the acceptance of the offer executing a transaction in accordance with the offer.

According to certain implementations, the method includes determining whether total participation associated with the offer meets a threshold participation. The method also includes allowing acceptance of the offer when the total participation associated with the offer does not meet the threshold participation and disallowing acceptance of the offer when the total participation associated with the offer meets the threshold participation.

In some implementations of the method, the offer is electronically communicated to the information handling device of the participant at a predetermined synchronization point during a public broadcast. The method can further include synchronously communicating real-time crowd funding information to the information handling device and broadcasting the real-time crowd funding information as part of the public broadcast.

According to another embodiment, an apparatus for electronic-based crowd funding includes an offer module that generates an offer of investment for broadcasting over an electronic broadcast medium. The apparatus also includes an information handling device that generates an electronic text-based message or input from a computer application that accepts the offer of investment. Further, the apparatus includes a verification module that verifies a source of the electronic text-based message or input from the computer application as a registered participant. Additionally, the apparatus includes a confirmation module that confirms acceptance of the offer of investment with the registered participant via an electronic text-based message or input to the computer application.

In some implementations, the apparatus further includes an application control module that synchronizes broadcasting the offer of investment over the electronic broadcast medium with communicating the offer of investment to the information handling device. The offer of investment can be broadcast over the electronic broadcast medium as part of a television program. Additionally, the application control module can synchronously push the offer of investment to the information handling device in response to the offer of investment being broadcast as part of the television program.

According to yet another embodiment, a system for electronic-based crowd funding includes a digital communication data network and a server coupled to the digital communication data network. The server includes an offer module that generates an offer of investment. The system also includes an electronic broadcast medium that broadcasts the offer of investment. Additionally, the system includes an information handling device that generates an electronic text-based message or input from a program specific computer application that accepts the offer of investment.

In some implementations of the system, the server includes an application control module that synchronizes broadcasting the offer of investment over the electronic broadcast medium with electronically transmitting the offer of investment to the information handling device. The server may include a registration module that registers the information handling device, and a verification module that verifies the registration of the information handling device. The application control module electronically transmits the offer of investment to the information handling device only after the information handling device verifies the registration of the information handling device.

In yet another embodiment, a system for syncing consumer engagement opportunities with broadcast media includes a digital communication data network, an electronic broadcast medium that broadcasts digital content, and a server coupled to the digital communication data network. The server synchronizes a communication of a consumer engagement opportunity over the data network with digital content being broadcast by the electronic broadcast medium. The communication is electronically separate from the digital content. The system also includes an information handling device that receives the consumer engagement opportunity from the server via the data network.

In some implementations of the immediately described system, the server includes a synchronization module that sets at least one synchronization point corresponding with the digital content, and links the consumer engagement opportunity with the at least one synchronization point. The server may include an offer module that communicates the consumer engagement opportunity to the information handling device when the at least one synchronization point is reached while broadcasting the digital content. The information handling device may include a digital content player that plays the digital content being broadcast by the electronic broadcast medium, where broadcasting of the digital content to the digital content player is requested via the information handling device. The system can further include a digital content player that plays the digital content being broadcast by the electronic broadcast medium, wherein the digital content player is physically separate from the information handling device. The digital content can be provided by a content distributer, and the synchronization module can provide a graphical user interface for allowing the content distributer to set the at least one synchronization point.

In some implementations of the above system, the server includes a registration module that registers the information handling device. The consumer engagement opportunity may not communicated to and received by the information handling device unless the information handling device has been registered by the registration module.

In some implementations of the above system, the server generates notifications to participate in future consumer engagement opportunities associated with future broadcasts of digital content, and adds registered users interested in participating in the future consumer engagement opportunities via an action required by the notifications to a wait-list.

In certain implementations of the above system, the server provides a wait-list that receives registered users interested in the consumer engagement opportunity after the consumer engagement opportunity has been suspended following a threshold level of participation in the consumer engagement opportunity has been met.

According to certain implementations, the server includes an offer module that sends notifications regarding the consumer engagement opportunity to the information handling device after a conclusion of the digital content.

In yet some implementations, the server includes an application control module that generates a unique audio sequence, the unique audio sequence having embedded therein information regarding the consumer engagement opportunity. The information handling device includes an interactive application module that receives the unique audio sequence, decodes the unique audio sequence to obtain the information regarding the consumer engagement opportunity, and provides a notification of the consumer engagement opportunity based on the information regarding the consumer engagement opportunity obtained from the unique audio sequence.

The described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. For example, numerous specific details are provided, such as examples of programming, software modules, user selections, network transactions, database queries, database structures, hardware modules, hardware circuits, hardware chips, etc. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

### BRIEF DESCRIPTION OF DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1A depicts one embodiment of a system for electronic-based crowd funding;

FIG. 1B depicts another embodiment of a system for electronic-based crowd funding;

FIG. 2 depicts one embodiment of a method of electronic-based crowd funding;

FIG. 3 depicts another embodiment of a method of electronic-based crowd funding;

FIG. 4 depicts one embodiment of a system for syncing consumer engagement opportunities with broadcast media; and

FIG. 5 depicts one embodiment of a method of syncing consumer engagement opportunities with broadcast media.

### DETAILED DESCRIPTION

Reference throughout this specification to “one embodiment,” “an embodiment,” or similar language means that a particular feature, structure, or characteristic described in connection with the embodiment is included in at least one embodiment of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the present disclosure, however, absent an express correlation to indicate otherwise, an implementation may be associated with one or more embodiments.

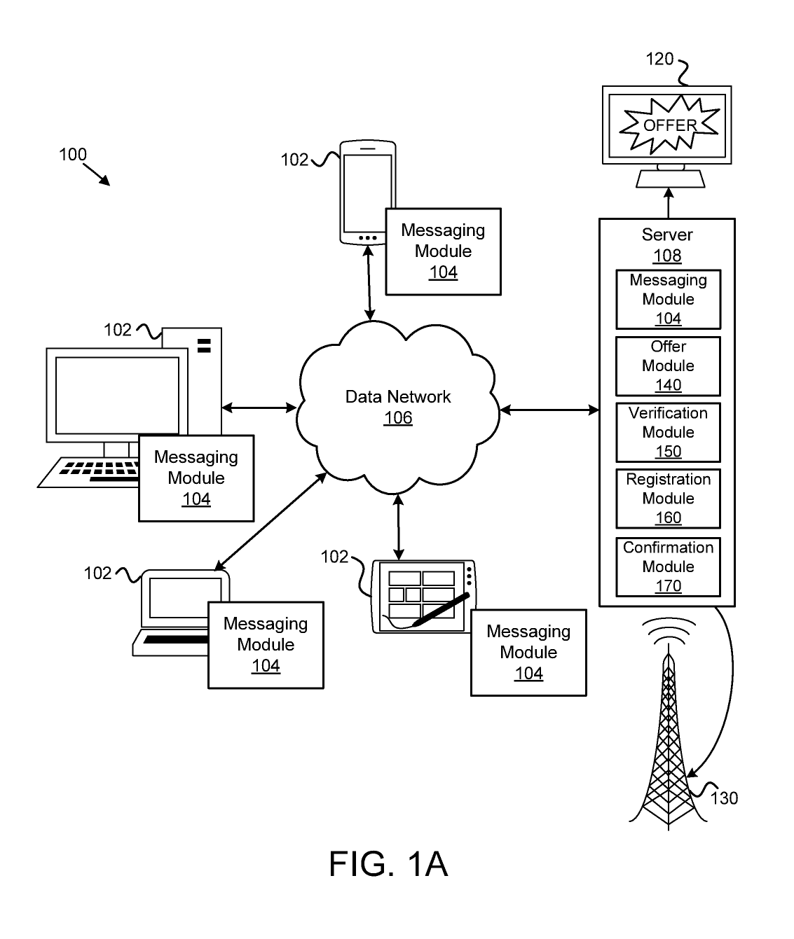

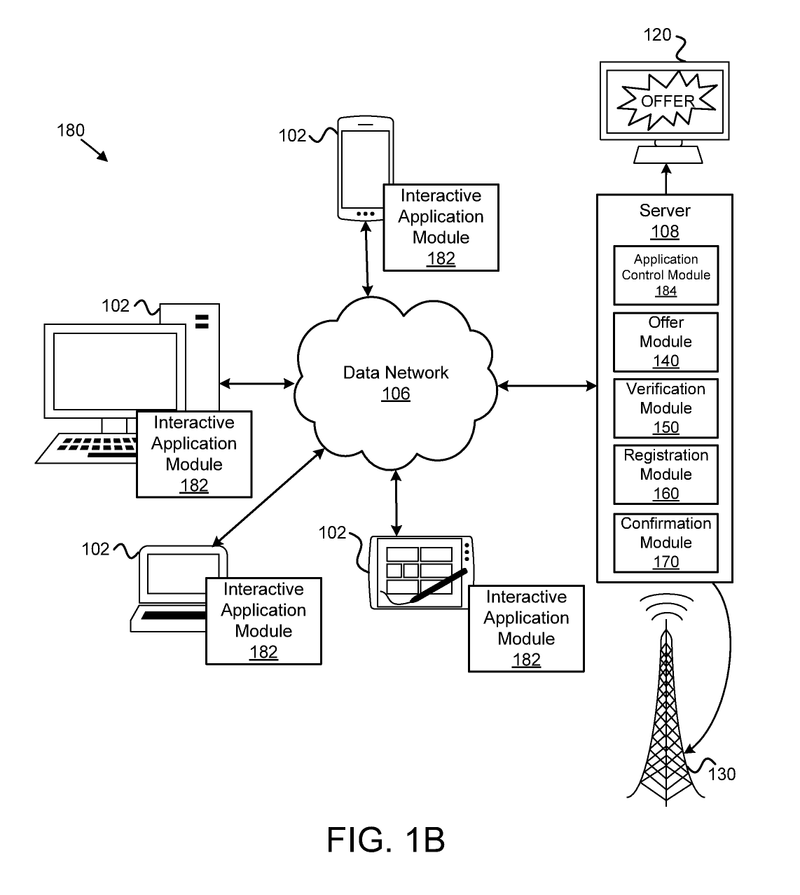

FIG. 1A depicts one embodiment of a system 100 for electronic-based crowd funding. As defined herein, crowd funding can include all crowd-based financial solicitations and transactions, such as, for example, peer-to-peer crowd lending, equity crowd funding, non-equity premium/product based crowd funding, accredited investor crowd funding, non-accredited investor crowd funding, etc. The system 100 includes information handling devices 102, messaging modules 104 on each information handling device 102, a digital communication data network 106, a server 108, a visual information broadcast system 120, and an audio information broadcast system 130, which are described in more detail below. Generally, the system 100 facilitates the public solicitation of participation in investment opportunities in various ventures and companies, and acceptance of such opportunities by the public via electronic text messaging and/or an interactive computer application. Conventional systems and methods of soliciting investment opportunities require the solicitations to be private solicitations targeting only accredited investors. Additionally, many conventional systems and methods are not equipped for relatively unsophisticated modes (e.g., text messaging, single-click or single-tap interfaces) for executing an investment in ventures and companies. In certain embodiments, the system 100 of the present disclosure increases the availability and accessibility for accredited and non-accredited investors alike to more quickly and easily invest in ventures and companies compared to previous systems and methods.

As shown, the information handling devices 102 can be any of various devices capable of handling (e.g., processing) electronic data. In some implementations, the information handling devices 102 include one or more mobile devices, such as smart phones, tablet computers, slate computer, e-book reader, laptops, optical head mounted displays, smart watches, personal desktop assistant (“PDA”), and/or the like. In other implementations, the information handling devices 102 can include one or more non-mobile or less-mobile devices, such as desktop computers, servers, and/or the like. According to the illustrated embodiment, the information handling devices 102 of the system 100 include, from the top and moving counter-clockwise, a smartphone, a desktop computer, a laptop computer, and a tablet computer. Although the system 100 is shown to have different types of information handling devices 102, in some embodiments, the system 100 may have one or more of a single type of information handling device. Additionally, although only single one of each type of device 102 is shown in FIG. 1A, the system 100 can have multiple devices of each type of device.

In some embodiments, the information handling devices 102 include operating systems, such as various versions of mobile and desktop operating systems provided by Microsoft®, Apple®, Linux, Android, and/or the like. For example, the information handling devices 102 may include a tablet running a version of Apple® iOS, a smart phone running a version of Windows® Mobile, a laptop running a distribution of Linux, and a desktop computer running a version of Windows®.

Each information handling device 102 can be configured to execute various services and/or programs, such as productivity applications, Internet applications, email clients, and/or the like. For example, the information handling devices 102 of the system 100 each have a messaging module 104 configured to send and receive text-based messages. The messaging module 104 sends and receives text-based messages to other electronic devices (e.g., information handling devices or servers) via a data network (e.g., the data network 106).

In some implementations, the messaging module 104 receives the content of a text-based message from a user through a message entry interface of the information handling device 102 or other device. The message entry interface may be a keyboard, a graphical user interface, microphone with voice-recognition functionality, and/or the like. Accordingly, the messaging module 104 generates a text-based message with content entered manually by a user through a message entry interface. The messaging module 104 converts the text-based message into a format compatible with the data network 106, adds a desired destination to the message, and transmits the text-based message to the desired destination over the data network.

The messaging module 104 may also be configured to receive text-based messages from other devices via the data network 106. Accordingly, the messaging module 104 can include data conversion tools to convert text-based messages received through the data network 106 to readable or audible messages accessible by a user of the device 102.

As defined herein, a text-based message can refer not only to conventional electronic text messages (e.g., Short Message Service (SMS) text messages, Multimedia Messaging Service (MMS) text messages, and the like) over a phone network, but also to other forms of electronic text-based messaging (e.g., e-mail, instant messaging, etc.) over an internet-based or other non-phone data network. It is contemplated that some systems and methods of the present disclosure are applicable to all forms of text-based messages, while others are dedicated to one particular type of text-based messages, such as conventional text messages sent and received over a phone network.

The data network 106 is a digital communication data network that transmits digital communications between the information handling devices 102 and/or the server 108. In some implementations, the digital communication network 106 may include a wireless network, such as a wireless telephone network, a local wireless network, such as a Wi-Fi network, a Bluetooth® network, and the like. According to yet some implementations, the digital communication data network 106 may include a wide area network (“WAN”), a storage area network (“SAN”), a local area network (“LAN”), an optical fiber network, the internet, or other digital communication network known in the art. The digital communication data network 106 also may include two or more networks. In some implementations, the digital communication data network 106 may include one or more servers, routers, switches, and/or other networking equipment. The digital communication network 106 may also include computer readable storage media, such as a hard disk drive, an optical drive, non-volatile memory, random access memory (“RAM”), or the like.

The server 108 can be any of various types of servers known in the art. In one embodiment, the server 108 includes one or more main frame computers, desktop computers, laptop computers, cloud servers, smart phones, tablet computers, and/or the like. As discussed above, the information handling devices 102 are communicatively coupled to the server 108 through the data network 106. In another embodiment, the information handling devices 102 access data stored on the server 108 through the data network 106. The server 108 also includes a messaging module 104 that operates in a manner similar to the messaging modules 104 of the information handling devices 102. For example, the messaging module 104 of the server 108 is configured to send and receive text-based messages to the information handling devices 102 over the data network 106.

Additionally, the server 108 includes an offer module 140 that generates an offer to invest in (e.g., participate in a capital-raising event associated with) a venture, company, or other investment vehicle. The offer module 140 determines the terms or constraints of the offer based on input from an investment opportunity organizer, which can supply the terms or constraints to the server 108 via the data network 106. Also, the offer may include instructions regarding how to accept or participate in the offer. Generally, the offer is accepted by sending a text-based message from an information handling device 102 to the server 108 in accordance with instructions provided in the offer. The offer generated by the offer module 140 can be any of various types of offers to invest in any of various investment vehicles in any number of ways.

For example, in some embodiments, the offer is an offer to purchase equity or ownership in a company at a set price. The offer to purchase equity may be defined in terms of shares (e.g., common stock) of the company to be purchased. The set price may be a one-time payment or may allow multiple installments over a defined period of time. In other embodiments, the offer is an offer to loan capital to a company in exchange for a predefined rate of return. According to yet other embodiments, the offer is an offer for a non-equity pledge to be paid at a later date. In yet further embodiments, the offer is an offer for capital in exchange for discounts on products and/or services.

In some implementations, the offer may remain open for a given amount of time or until a predetermined threshold is met. In one particular implementation, the offer is open only for a given time period (e.g., 1-hour, 24-hours, 1 week, etc.) regardless of the amount of capital raised during the time period. However, in other implementations, an offer will remain open until a predetermined amount of capital is raised regardless of the amount of time the offer is open.

The offer module 140 broadcasts the generated offer to potential investors or participants via one or more data network and/or broadcast systems. As shown in FIG. 1A, the server 108 is configured to transmit or broadcast a generated offer to at least one of a visual information broadcast system 120 or an audio information broadcast system 130. Alternatively, the server 108 may be configured to transmit or broadcast a generated offer to the information handling devices 102 directly. Generally, the offer utilizes the broadcast systems to transmit and present the offer to large groups of people, such as the public at-large. Accordingly, in many implementations, the offers are not targeted to small groups of people, such as only accredited inventors. Rather, preferably, the offers are made available to all who may be interested, whether accredited or not, in a non-selective manner. However, in some implementations, the offers can be to targeted groups (e.g., known investors) having a smaller number of people.

The visual information broadcast system 120 can be any of various information communication systems that utilize visual displays for communicating information. Of course, the visual displays can be accompanied by corresponding audio. In one embodiment, the visual information broadcast system 120 is a television broadcast system including a television or other monitor for displaying visual content. Accordingly, the offer can be communicated to potential investors or participants as part of a television program or commercial. In the same or other embodiment, the visual information broadcast system 120 is an internet-based communication system including a monitor for displaying visual content. In such an embodiment, the offer can be communicated to potential investors or participants as part of an internet-based program (e.g., webinar) or website.

The audio information broadcast system 130 can be any of various information communication systems that utilize or rely nearly exclusively on audio for communicating information. In one embodiment, the audio information broadcast system 130 can be a radio transmission system with radio-wave transmitting towers as depicted and/or satellites. Accordingly, the offer can be communicated to potential investors or participants as part of a radio program or commercial.

After an offer is broadcast to the public over the information communication systems, those desiring to accept or participate in the offer to invest will generate a text-based message from their information handling device 102, and send the message to the messaging module 104 of the server 108. In some implementations, the text-based message includes a request to participate in or accept the offer, and may include a code (e.g., a 5-digit code) associated with the acceptance or request to participate that is sent to a number (e.g., 6-digit number) associated with the server 108. The server 108 includes a verification module 150 that verifies the sender of the text-based message. In certain implementations, users that desire to accept an offer should first be registered users of the system 100. A user can register with the system 100 by submitting any of various personal data about the user (e.g., contact information, personal and/or household income, social security number, information handling device identification or phone number, bank account information, credit card information, etc.) to the server 108. A registration module 160 of the server 108 receives the personal data, stores the data in a database, and identifies the user as a registered user. Accordingly, the verification module 150 may be configured to verify that a sender of a text-based message is a registered user identified by the registration module 160. Additionally, or alternatively, the verification module 150 may verify that the information handling device 102 that generated the text-based message is associated with a registered user.

In addition to verifying that a sender is a registered user, the verification module 150 can also be configured to verify that a registered user financially qualifies to accept or participate in the offer. For example, in certain implementations, a registered user may accept an offer only when the investment associated with the offer remains below a threshold percentage (e.g., 5%) of the annual income of the registered user. Should the investment be more than the threshold percentage, the verification module refuses the acceptance of the offer and disallows the transaction. Constraints other than staying below a minimum threshold percentage of income may be enforced, such as failing to provide a preferred method of payment, having an account with insufficient funds, or using a declined or expired credit card.

Should the verification module 150 verify that the text-based message accepting the offer was sent by a registered user (and/or sent from a registered device) and the registered user financially qualifies to accept the offer, a confirmation module 170 of the server 108 is configured to seek confirmation from the registered user that acceptance of the offer and fulfillment of the transaction is desired. The confirmation may be in the form of a text-based message generated by the messaging module 104 and sent to the information handling device 102 that requests confirmation from the registered user. In response to receiving the confirmation request, the sender may confirm his intentions by sending confirmation information (e.g., PIN number, passwords, etc.) via a text-based message back to the server 108. The confirmation information is verified by the confirmation module 170 and/or verification module 150, and the transaction is fulfilled by debiting the registered user according to the terms of the offer. The confirmation module 170 also may be configured to send a confirmation (e.g., receipt) to the registered user to confirm that the investment transaction has been completed.

According to another embodiment shown in FIG. 1B, a system 180 for electronic-based crowd funding includes features similar to the features of the system 100 of FIG. 1A, with like numbers referring to like features. Like the system 100, the system 180 also facilitates the public solicitation of investment opportunities in various ventures and companies, and acceptance of such opportunities by the public via electronic communication. However, instead of text-based messaging to solicit and accept offers for investment as with the system 100, the system 180 utilizes an interactive computer application to solicit and/or accept offers for investment. More specifically, instead of, or in addition to, a messaging module 104, each information handling device 102 includes an interactive application module 182 configured to execute a computer application (which can include a website) on the information handling device that facilitates the solicitation and acceptance of an offer, the confirmation of an acceptance, and the registration of a new investor participant in an interactive manner. Similarly, instead of, or in addition to, a messaging module 104, the server 108 includes an application control module 184 that controls the content for the interactive computer applications and facilitates the exchange of data between the server and the interactive application modules 182.

Additionally, the application control module 184 can be configured to synchronize offers presented to the public via broadcast systems (e.g., television programs) and the computer applications executed on information handling devices by the interactive application modules 182. In other words, offers presented on television can be pushed to the computer application of the user's information handling devices. For example, public audience members watching a television program can access the computer application on their information handling devices 102 to view and accept (e.g., in real time or concurrently with) the offers presented on the television program. In one implementation, the interactive application module 182 can alert a user of the availability to accept an offer presented on the television program via a notification, and provide a simple interactive method to accept the offer, such as selecting (e.g., touching) an “accept” or “I'm in” icon on the screen of the information handling device.

In some embodiments, the period of time for accepting an offer presented in a live or synchronous event may be extended beyond the conclusion of the live event. Accordingly, the offer module 140 may be configured to send notifications to registered information handling devices 102 following a live event to provide the user an opportunity to participate in the synchronous or real-time offer after the live event. The notification to the information handling device 102 to participate in the offer may be automatically sent to the user after a predetermined period of time following the conclusion of the live event. Alternatively, the user may manually trigger the notification to participate in the offer by performing an action, such as viewing an asynchronous, tape-delay, or copy of the live event. The details of the offer provided by the notification following the live event may be the same as or different than the details of the offer communicated during the live event.

The computer application or website on the information handling device 102 may dynamically (e.g., synchronously) interact with a television program in other ways, such as providing real-time investor activity tracking to users of the computer application or website during and between television programs. The real-time investor activity can include, for example, the number of positions available, the amount of capital raised, the status of the crowd funding event. Other dynamic interactions between the television program and computer applications and websites may include tracking the velocity of crowd funding campaigns, providing a grading scale for crowd fund campaigns present on the television program, announcing news-worthy information (e.g., celebrity investments/endorsements, distribution deals, product testing breakthroughs, etc.), selling a product embedded in the television program, and tracking the sales of such products.

In some embodiments, the server 108 may provide wait-list functionality for registered users desiring to participate in an offer after a threshold level of participation has been met. After the threshold level of participation is met, the server 108 may suspend or discontinue the offer permanently or temporarily. However, after an offer is suspended, users may join a wait-list until the offer becomes available again, which may occur when participants who have previously accepted an offer fail to execute the offer for any number of reasons.

According to yet certain embodiments, the server 108 may provide a wait-list for future offers associated with content that is to be broadcast at a later time. The opportunity to join the wait-list may be provided by the server 108 via a notification to a user's information handling device 102. The notification may be communicated to the information handling device 102 automatically, such as at a predetermined time prior to the broadcast of the content. Alternatively, the notification to participate in the future offer may be communicated to the information handling device 102 manually via the user performing an action, such as by viewing an advertisement for the future event. Following the notification, the user is allowed to join the wait-list via an action required by the notification, which gives the user priority access to future offers.

According to one embodiment, the application control module 184 is configured to generate an audible QR code or audible synchronization code. The audible codes or sequences embed information regarding offers from the offer module 140 to create a unique audio fingerprint that is recognized and generates a response from the interactive application module 182 of one or more information handling devices 102. The response can be an interactive two-screen experience or a single screen experience associated with an offer linked to the audible code. The offer information is embedded into the audible codes via modulation of the audio properties of the audible codes. Some audio properties include the frequency, duration, intervals, harmony, tone, and the like.

According to one example, during a live public broadcast of content, the audible codes may be embedded into the content at predetermined times, such that at the predetermined times during the broadcast, the audible codes are played or heard by viewers of the content. When played, the interactive application module 182 of an information handling device 102 recognizes the audible code, decodes or interprets the codes, and communicates the offer embedded into the code via audio, video, or tactile features of the information handling device. The audible codes can be predetermined or preconfigured prior to a live broadcast, and embedded into the live broadcast as desired. Accordingly, the preconfigured audible codes can be transferred (e.g., sold) to content distributers for inclusion in live broadcasts. In some implementations, the audible code utilizes ultrasonic frequencies undetectable to the human ear, and interactive application module 182 is configured to detect and decode the ultrasonic audible codes.

In one specific example, during a specific portion (e.g., during player introductions) of a live broadcast of a sporting event, an audible code specific to the specific portion (e.g., an audible code associated with a particular player) may be played. The interactive application module 182 of the information handling device 102 of a registered user recognizes and decodes the audible code to communicate the offer (e.g., a request to purchase personalized game gear corresponding to the particular player, a link to the particular player's website, etc.) embedded in the code. The user then decides whether to accept the offer.

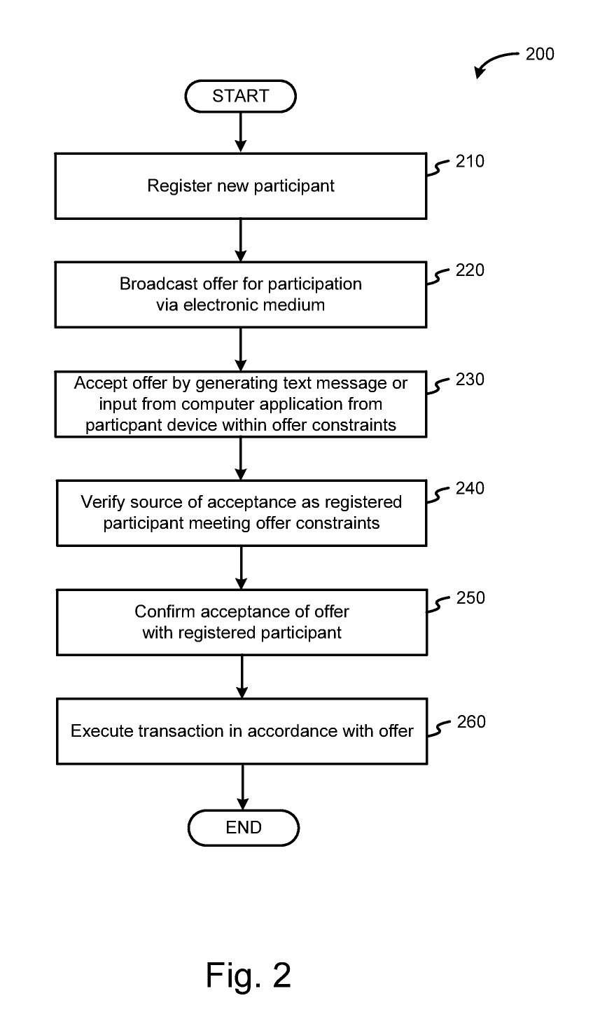

Referring to FIG. 2, one embodiment of a method 200 for electronic-based crowd funding is shown. The method 200 can be executed by any of various systems, such as the system 100, having any of various modules, such as those modules described above in reference to FIGS. 1A or 1B. The method 200 begins with the registration of a new participant at 210. A participant can also be considered an investor or simply a user. Registration of the participant at 210 can be required before the participant is able to accept offers to invest. The method 200 includes broadcasting an offer for participation in a crowd funding event or offer via an electronic medium at 220. The offer can include payment for equity, interest, and/or discounted product, or a pledge for future payment. The electronic medium can be television, internet, radio, and the like. The method 200 includes accepting the offer by generating (e.g., sending) a text-based message or input from a program-specific computer application from an electronic messaging device of the registered participant that complies with preset offer constraints (e.g., time constraints, financial constraints, etc.) at 230. Additionally, the method 200 includes verifying the source of the text-based message or input communicating the acceptance as a registered participant meeting the offer constraints at 240. The method 200 can also include confirming the acceptance of the offer with the registered participant at 250. Lastly, the method 200 includes executing a transaction in accordance with the accepted offer at 260.

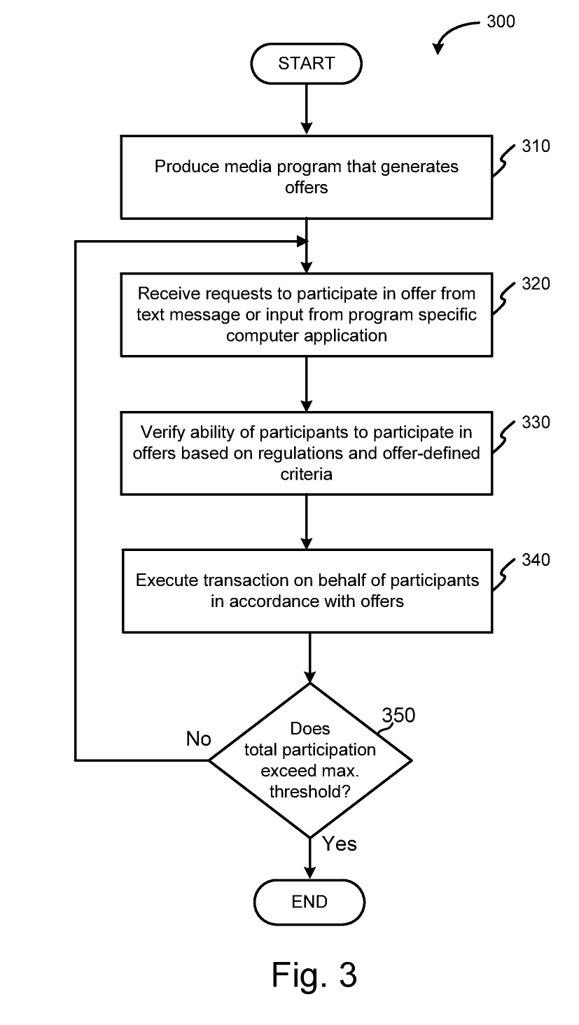

According to one embodiment, the system 100 can be utilized in a television program that promotes the growth of start-up companies. For example, according to one embodiment shown in FIG. 3, a method 300 for electronic-based crowd funding includes producing a media program (e.g., television program) that generates offers to participate in crowd funding events for the public or media-viewing audience at 310. The method 300 also includes receiving requests to participate in offers via electronic text messages or input from program specific computer application at 320. Then, the method 300 includes verifying the ability of participants to participate in offers based on regulation and offer-defined criteria at 330, such as the annual income of the participants meeting a minimum income threshold corresponding with the offers. Basically, in some embodiments, the participants must have an annual income that exceeds a percentage of the potential investment. After verification 330, the method includes executing a transaction on behalf of the participants in accordance with the accepted offers at 340. The method 300 may also include determining whether a total participation associated with an offer (e.g., total capital raised) exceeds a maximum threshold at 350. If the total participation associated with an offer exceeds a maximum threshold at 350, then the method 300 ends. However, if the total participation associated with an offer does not exceed a maximum threshold at 350, then the method 300 may continue to receive additional requests to participate in the offer at 320. In this manner, in some implementations, the method 300 continues to receive requests, verify participants' ability to participate, and execute transactions until a total participation in an offer exceeds a maximum threshold.

Although the method 300 has been described in association with equity investment offers, in other embodiments, the investment offers can be other types of investment offers, such as non-equity investment offers.

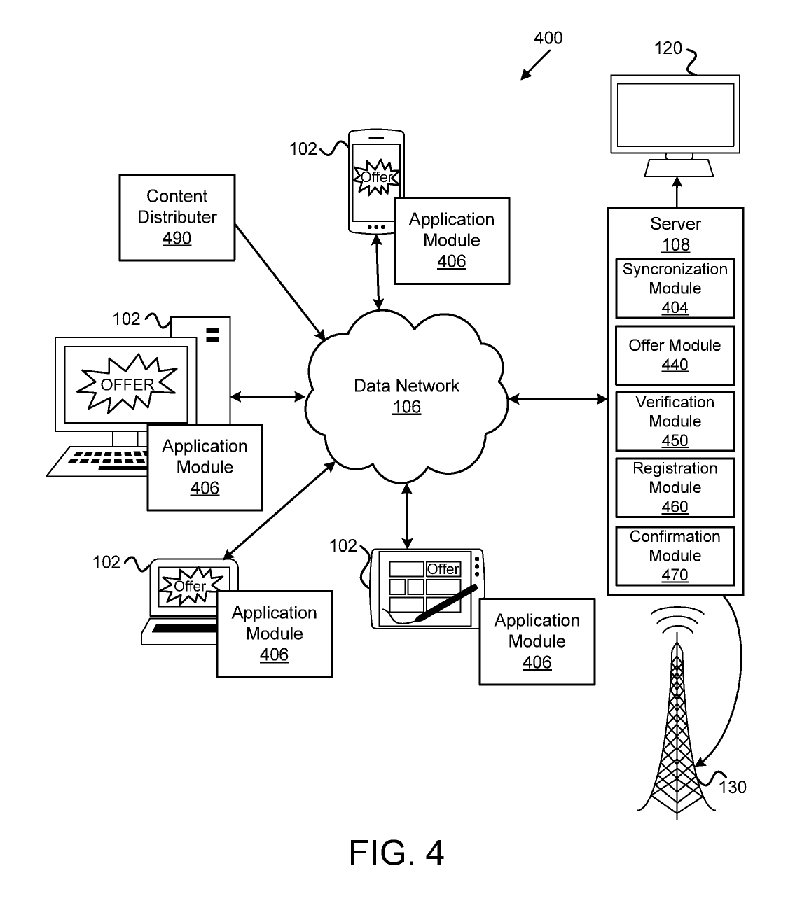

Referring to FIG. 4, according to one embodiment, a system 400 for syncing consumer engagement opportunities with broadcast media is shown. Generally, the system 400 automatically generates at preselected times or intervals during the public or private broadcast of media one or more opportunities for a user to engage in an activity related to the media. The media may be in the form of content provided by a content distributer 490. The content may be publically broadcast via the public broadcast system 120 and/or audio information broadcast system 130, and played by a digital content player, which can be one of the information handling devices 102 or other playback devices physically separate from the information handling devices. Alternatively, the content is privately broadcast to one or more information handling devices 102 of a user for private viewing based on the user's selection to receive the content.

The server 108 of the system 400 includes a synchronization module 404, an offer module 140, and a registration module 460. The synchronization module 404 creates synchronization points relative to the content and links engagement opportunities or offers to the synchronization points. In one implementation, the synchronization points are selected according to the preferences of the content distributer 490, such as via a graphical user interface of the synchronization module 404. In other words, the content distributer 490 provides the content and selects where to insert synchronization points into the content. Additionally, the content distributer 490 may determine the type of offers to be linked to the synchronization points. According to some implementations, the content distributer 490 uploads content, offer, and synchronization point information to the synchronization module 404 of the server 108. The synchronization module 404 may provide an interface to the content distributer 490 to facilitate the uploading of content, offer, and synchronization point information to the server 108. The content information may include the content itself or information regarding the network location of the content. The offer information includes the terms of the offer, as well as the aesthetic aspects of the offer in certain implementations. The synchronization point information includes the temporal location along the playback of the content when offers should be made available to the user receiving the content. In some implementations, the content distributer 490 selects as synchronization points parts of the content most relevant to the offer or most likely to incite acceptance of the offer or further engagement of the user.

Each of the information handling devices 102 includes an application module 406 configured to execute a software application on the information handling device. The application module 406 facilitates interaction between the user and the server 108 via the data network 106. In one implementation, the application module 406 includes a user registration component that provides for the registration of the user, and/or the user's device, with the server 108. More specifically, as described above, after receiving information from the user via the application module 406, the registration module 460 stores the information in a database and is configured to identify the user as a registered user. The verification module 450 verifies the user as a registered user and the confirmation module 470 seeks confirmation from the user that fulfillment of an offer is desired. The application module 406 may also be configured to communicate offers to the user from the offer module 140. Offers may be communicated to the user via visual, audio, and/or tactile means.

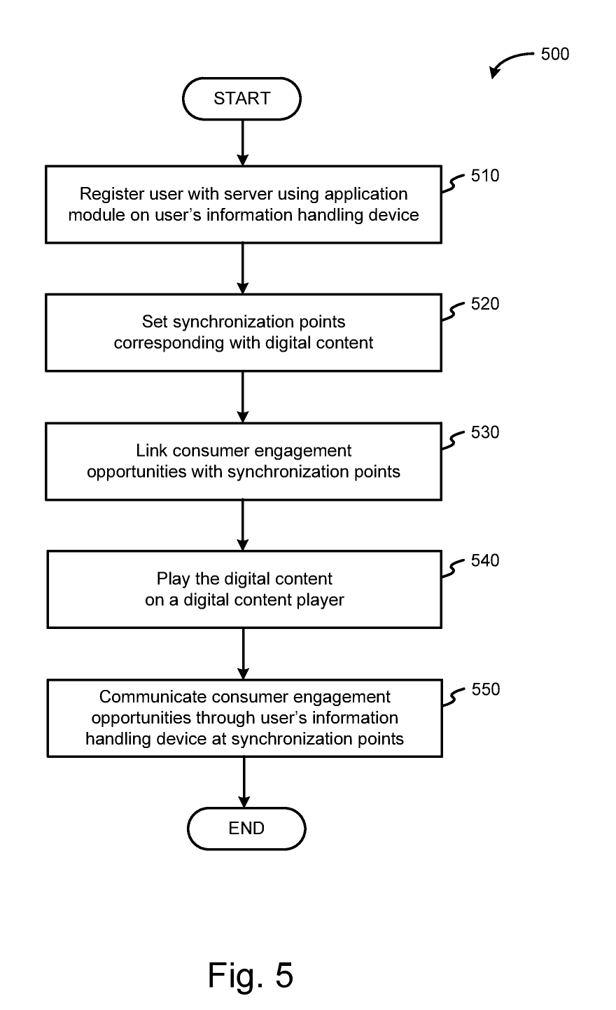

According to one embodiment, a method 500 of syncing consumer engagement opportunities (e.g., offers) with broadcast media is shown in FIG. 5. The method 500 may be practiced using the system 400 of FIG. 4. Initially, the method 500 includes registering a user with a server using an application module on the user's information handling device at 510. The method 500 also includes setting one or more synchronization points corresponding with digital content at 520. The synchronization points can be set by a content distributor that provides the content. Further, the synchronization points can be set and stored on the server. The method 500 additionally includes linking consumer engagement opportunities with the synchronization points at 530. Prior to linking the consumer engagement opportunities to the synchronization points, the terms and design of the consumer engagement opportunities can be set by the content distributer 490 or by a service provider via the server 108. The consumer engagement opportunities are stored on the server in some implementations.

The method 500 includes playing the digital content on a digital content player at 540. In one implementation, the digital content is selected by the user to be played. For example, the digital content may be a video clip embedded within a website. Playing the digital content in such an example includes clicking on the video clip for playback. Alternatively, the digital content may be played via a steaming video or audio service. The digital content player can be one of the information handling devices 102. For example, in some implementations, the same information handling device used to register the user at 510 can be used for playing the digital content at 540.

As the digital content is being played at 540, the method 500 includes communicating consumer engagement opportunities through a user's information handling device at the synchronization points set at 520. The consumer engagement opportunities can be communicated through the digital content player used to play the digital content or on another information handling device. The consumer engagement opportunities can be audible, visual, and/or tactile. For example, the consumer engagement opportunities may be pop-up graphical user interfaces, in-application notifications, etc. The user may then ignore, cancel, or accept the consumer engagement opportunities after they are communicated. In certain implementations, the consumer engagement opportunities are communicated only to a registered information handling device being used by a registered user. Prior to communicating a consumer engagement opportunity, the verification module 450 of the server 108 may verify the registration of the user and information handling device.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the software portions are stored on one or more computer readable mediums.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to schematic flowchart diagrams and/or schematic block diagrams of methods, apparatuses, systems, and computer program products according to embodiments of the present disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present disclosure. In this regard, each block in the schematic flowchart diagrams and/or schematic block diagrams may represent a module, segment, or portion of code, which comprises one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer instructions.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

The present disclosure may be embodied in other specific forms without departing from its spirit or essential characteristics. The described embodiments are to be considered in all respects only as illustrative and not restrictive. The scope of the present disclosure is, therefore, indicated by the appended claims rather than by the foregoing description. All changes which come within the meaning and range of equivalency of the claims are to be embraced within their scope.

What is claimed is:

1. A method for electronic-based crowd funding, comprising:
broadcasting an offer for participating in a crowd funding event via an electronic medium; and
accepting the offer by generating from an information handling device of a participant an electronic text-based message or input from a computer application.

2. The method of claim 1, further comprising registering the participant, and verifying the electronic text-based message or input from the computer application is from a registered participant.

3. The method of claim 1, further comprising verifying the participant qualifies to participate in the offer based on at least one of regulation and offer-defined criteria.

4. The method of claim 1, further comprising confirming with the participant acceptance of the offer, and following confirmation of the acceptance of the offer executing a transaction in accordance with the offer.

5. The method of claim 1, further comprising determining whether total participation associated with the offer meets a threshold participation, the method further comprising allowing acceptance of the offer when the total participation associated with the offer does not meet the threshold participation and disallowing acceptance of the offer when the total participation associated with the offer meets the threshold participation.

6. The method of claim 1, wherein the offer is electronically communicated to the information handling device of the participant at a predetermined synchronization point during a public broadcast.

7. The method of claim 6, further comprising synchronously communicating real-time crowd funding information to the information handling device and broadcasting the real-time crowd funding information as part of the public broadcast.

8. An apparatus for electronic-based crowd funding, comprising:
an offer module that generates an offer of investment for broadcasting over an electronic broadcast medium;
an information handling device that generates an electronic text-based message or input from a computer application that accepts the offer of investment;
a verification module that verifies a source of the electronic text-based message or input from the computer application as a registered participant; and
a confirmation module that confirms acceptance of the offer of investment with the registered participant via an electronic text-based message or input to the computer application.

9. The apparatus of claim 8, further comprising an application control module that synchronizes broadcasting the offer of investment over the electronic broadcast medium with communicating the offer of investment to the information handling device.

10. The apparatus of claim 9, wherein the offer of investment is broadcast over the electronic broadcast medium as part of a television program, and wherein the application control module synchronously pushes the offer of investment to the information handling device in response to the offer of investment being broadcast as part of the television program.

11. A system for electronic-based crowd funding, comprising:
a digital communication data network;
a server coupled to the digital communication data network, the server comprising an offer module that generates an offer of investment;
an electronic broadcast medium that broadcasts the offer of investment; and
an information handling device that generates an electronic text-based message or input from a program specific computer application that accepts the offer of investment.

12. The system of claim 11, wherein the server comprises an application control module that synchronizes broadcasting the offer of investment over the electronic broadcast medium with electronically transmitting the offer of investment to the information handling device.

13. The system of claim 12, wherein the server comprises a registration module that registers the information handling device, and a verification module that verifies the registration of the information handling device, and wherein the application control module electronically transmits the offer of investment to the information handling device only after the information handling device verifies the registration of the information handling device.

14. A system for syncing consumer engagement opportunities with broadcast media, comprising:
a digital communication data network;
an electronic broadcast medium that broadcasts digital content;
a server coupled to the digital communication data network, the server synchronizing a communication of a consumer engagement opportunity over the data network with digital content being broadcast by the electronic broadcast medium, the communication being electronically separate from the digital content; and
an information handling device that receives the consumer engagement opportunity from the server via the data network.

15. The system of claim 14, wherein the server comprises a synchronization module that sets at least one synchronization point corresponding with the digital content, and links the consumer engagement opportunity with the at least one synchronization point.

16. The system of claim 15, wherein the server comprises an offer module that communicates the consumer engagement opportunity to the information handling device when the at least one synchronization point is reached while broadcasting the digital content.

17. The system of claim 15, wherein the information handling device comprises a digital content player that plays the digital content being broadcast by the electronic broadcast medium, and wherein broadcasting of the digital content to the digital content player is requested via the information handling device.

18. The system of claim 15, further comprising a digital content player that plays the digital content being broadcast by the electronic broadcast medium, wherein the digital content player is physically separate from the information handling device.

19. The system of claim 15, wherein the digital content is provided by a content distributer, the synchronization module providing a graphical user interface for allowing the content distributer to set the at least one synchronization point.

20. The system of claim 14, wherein the server comprises a registration module that registers the information handling device, and wherein the consumer engagement opportunity is not communicated to and received by the information handling device unless the information handling device has been registered by the registration module.

21. The system of claim 14, wherein the server generates notifications to participate in future consumer engagement opportunities associated with future broadcasts of digital content, and adds registered users interested in participating in the future consumer engagement opportunities via an action required by the notifications to a wait-list.

22. The system of claim 14, wherein the server provides a wait-list that receives registered users interested in the consumer engagement opportunity after the consumer engagement opportunity has been suspended following a threshold level of participation in the consumer engagement opportunity has been met.

23. The system of claim 14, wherein the server comprises an offer module that sends notifications regarding the consumer engagement opportunity to the information handling device after a conclusion of the digital content.

24. The system of claim 14, wherein the server comprises an application control module that generates a unique audio sequence, the unique audio sequence having embedded therein information regarding the consumer engagement opportunity, and the information handling device comprising an interactive application module that receives the unique audio sequence, decodes the unique audio sequence to obtain the information regarding the consumer engagement opportunity, and provides a notification of the consumer engagement opportunity based on the information regarding the consumer engagement opportunity obtained from the unique audio sequence.
